(19) United States
(12) Patent Application Publication
(10) Pub. No.: US 2026/0127776 A1
(43) Pub. Date: May 7, 2026

(54) METHOD, APPARATUS, AND MEDIUM FOR VIDEO PROCESSING

(71) Applicant: Bytedance Inc., Los Angeles, CA (US)

(72) Inventors: Yue LI, Los Angeles, CA (US); Kai ZHANG, Los Angeles, CA (US); Li ZHANG, Los Angeles, CA (US)

(21) Appl. No.: 19/438,423

(22) Filed: Dec. 31, 2025

Related U.S. Application Data
(63) Continuation of application No. PCT/US2024/036580, filed on Jul. 2, 2024.
(60) Provisional application No. 63/511,813, filed on Jul. 3, 2023.

(51) Int. Cl. G06T 9/00; H04N 19/184

(52) U.S. Cl. CPC G06T 9/002; H04N 19/184

(57) ABSTRACT

Embodiments of the present disclosure provide a solution for video processing. A method for video processing is proposed. In the method, a conversion between a current video unit of a video and a bitstream of the video is performed. A neural network (NN) filter is applied to the current video unit for the conversion. At least one output of at least one intermediate layer in the NN filter is normalized with layer normalization.

### CROSS REFERENCE TO RELATED APPLICATION

This application is a continuation of International Application No. PCT/US2024/036580, filed on Jul. 2, 2024, which claims the benefit of U.S. Provisional Patent Application No. 63/511,813, entitled “METHOD, APPARATUS, AND MEDIUM FOR VIDEO PROCESSING”, and filed on Jul. 3, 2023. The entire contents of these applications are hereby incorporated by reference in their entireties.

### FIELD

Embodiments of the present disclosure relates generally to video coding techniques, and more particularly, to neural network (NN)-based filter for video coding.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of conventional video coding techniques is generally very low, which is undesirable.

### SUMMARY

Embodiments of the present disclosure provide a solution for video processing.

In a first aspect, a method for video processing is proposed. The method comprises: performing a conversion between a current video unit of a video and a bitstream of the video, wherein a neural network (NN) filter is applied to the current video unit for the conversion, wherein at least one output of at least one intermediate layer in the NN filter is normalized with layer normalization. The method in accordance with the first aspect of the present disclosure applies a NN filter with layer normalization. The coding efficiency can thus be improved.

In a second aspect, another method for video processing is proposed. The method comprises: performing a conversion between a current video unit of a video and a bitstream of the video, wherein a neural network (NN) filter is applied to the current video unit for the conversion, wherein the NN filter comprises a vanilla convolutional layer and at least one of: a depth-wise convolutional layer, or a group convolutional layer. The method in accordance with the second aspect of the present disclosure applies a NN filter with a depth-wise convolutional layer or a group convolutional layer. The coding efficiency can thus be improved.

In a third aspect, another method for video processing is proposed. The method comprises: performing a conversion between a current video unit of a video and a bitstream of the video, wherein a neural network (NN) filter is applied to the current video unit for the conversion based on an attention. The method in accordance with the third aspect of the present disclosure applies the attention for a NN filter. The coding efficiency can thus be improved.

In a fourth aspect, an apparatus for video processing is proposed. The apparatus comprises a processor and a non-transitory memory with instructions thereon. The instructions upon execution by the processor, cause the processor to perform a method in accordance with the first, second, or third aspect of the present disclosure.

In a fifth aspect, a non-transitory computer-readable storage medium is proposed. The non-transitory computer-readable storage medium stores instructions that cause a processor to perform a method in accordance with the first, second, or third aspect of the present disclosure.

In a sixth aspect, another non-transitory computer-readable recording medium is proposed. The non-transitory computer-readable recording medium stores a bitstream of a video which is generated by a method performed by an apparatus for video processing. The method comprises: generating the bitstream of the video from a current video unit of the video, wherein a neural network (NN) filter is applied to the current video unit of the video, wherein at least one output of at least one intermediate layer in the NN filter is normalized with layer normalization.

In a seventh aspect, another non-transitory computer-readable recording medium is proposed. The non-transitory computer-readable recording medium stores a bitstream of a video which is generated by a method performed by an apparatus for video processing. The method comprises: generating the bitstream of the video from a current video unit of the video, wherein a neural network (NN) filter is applied to the current video unit of the video, wherein the NN filter comprises a vanilla convolutional layer and at least one of: a depth-wise convolutional layer, or a group convolutional layer.

In an eighth aspect, another non-transitory computer-readable recording medium is proposed. The non-transitory computer-readable recording medium stores a bitstream of a video which is generated by a method performed by an apparatus for video processing. The method comprises: generating the bitstream of the video from a current video unit of the video, wherein a neural network (NN) filter is applied to the current video unit of the video based on an attention.

In a ninth aspect, a method for storing a bitstream of a video is proposed. The method comprises: generating the bitstream of the video from a current video unit of the video, wherein a neural network (NN) filter is applied to the current video unit of the video, wherein at least one output of at least one intermediate layer in the NN filter is normalized with layer normalization; and storing the bitstream in a non-transitory computer-readable recording medium.

In a tenth aspect, a method for storing a bitstream of a video is proposed. The method comprises: generating the bitstream of the video from a current video unit of the video, wherein a neural network (NN) filter is applied to the current video unit of the video, wherein the NN filter comprises a vanilla convolutional layer and at least one of: a depth-wise convolutional layer, or a group convolutional layer; and storing the bitstream in a non-transitory computer-readable recording medium.

In an eleventh aspect, a method for storing a bitstream of a video is proposed. The method comprises: generating the bitstream of the video from a current video unit of the video, wherein a neural network (NN) filter is applied to the current video unit of the video based on an attention; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates an example diagram showing an example of raster-scan slice partitioning of a picture;

FIG. 5 illustrates an example diagram showing an example of rectangular slice partitioning of a picture;

FIG. 6 illustrates an example diagram showing an example of a picture partitioned into tiles, bricks, and rectangular slices;

FIG. 7A illustrates an example diagram showing CTBs crossing the bottom picture border;

FIG. 7B illustrates an example diagram showing CTBs crossing the right picture border;

FIG. 7C illustrates an example diagram showing CTBs crossing the right bottom picture border;

FIG. 8 illustrates an example diagram showing an example of encoder block diagram;

FIG. 9 illustrates the pre-processing and post-processing units;

FIG. 10 illustrates architecture of the CNN in filter set 0;

FIG. 11 illustrates an implementation of the CNN in filter set 0;

FIG. 12 illustrates an encoder optimization 2;

FIG. 13A to FIG. 13C illustrate architecture of the CNN in filter set 1, respectively;

FIG. 14 illustrates a temporal in-loop filter. Only head part is illustrated, other parts remain the same as in FIG. 13B and FIG. 13C. {Col 0, Col 1} refers to collocated samples from the first picture in both reference picture lists;

FIG. 15A shows parameter selection at encoder side;

FIG. 15B shows parameter selection at decoder side;

FIG. 16 shows prediction of the current w×h block Y from the context X of reference samples around Y via the neural network-based intra prediction mode. Here, w=8 and h=4;

FIG. 17 shows decomposition of the context X of reference samples surrounding the current w×h block Y into the available reference samples X̅ and the unavailable reference samples Xᵤ. Here, w=8 and h=4. In the illustrated case, the number of unavailable reference samples reaches its maximum value;

FIG. 18 shows intra prediction mode signaling for the current w×h luma CB framed in orange in dashed line. The coordinates of the pixel at the top-left of this CB are (y, x). The bin value of a nnFlag value appears in bold gray. Here, h=8, w=4, x=8, and y=0;

FIG. 19 illustrates a flowchart of a method for video processing in accordance with some embodiments of the present disclosure;

FIG. 20 illustrates a flowchart of another method for video processing in accordance with some embodiments of the present disclosure;

FIG. 21 illustrates a flowchart of another method for video processing in accordance with some embodiments of the present disclosure; and

FIG. 22 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

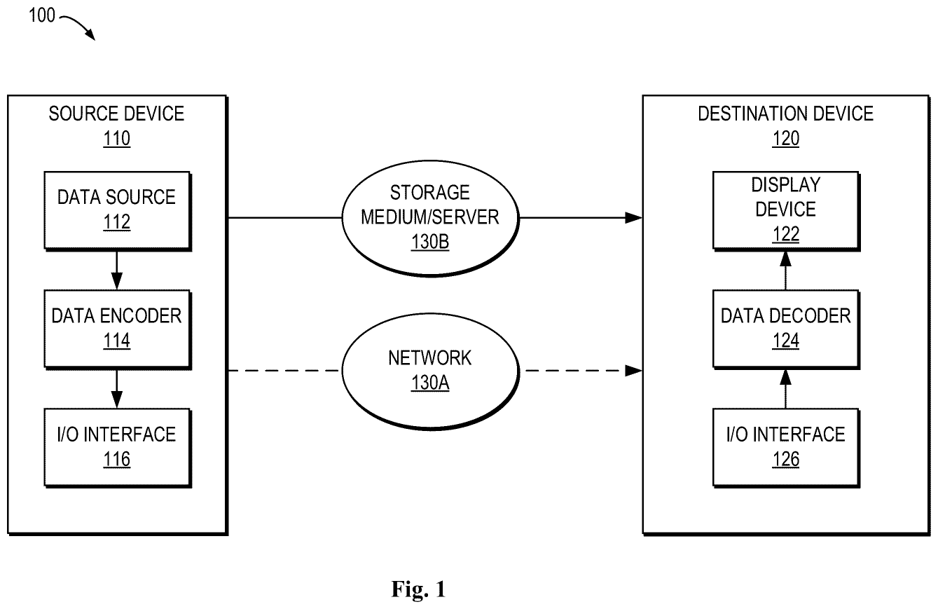

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

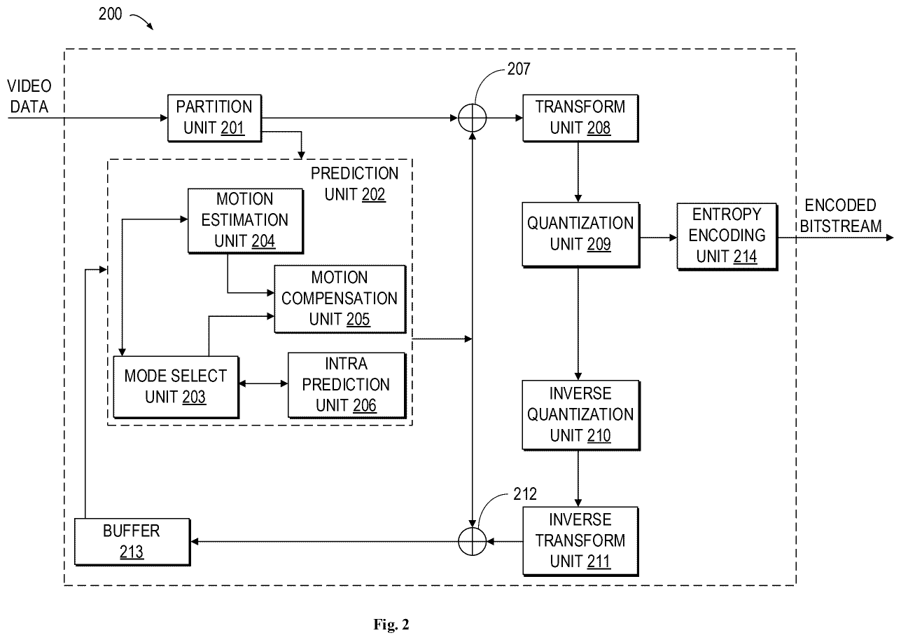

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a prediction unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the prediction unit 202 may include an intra block copy (IBC) unit. The IBC unit may perform prediction in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter prediction (CIIP) mode in which the prediction is based on an inter prediction signal and an intra prediction signal. The mode select unit 203 may also select a resolution for a motion vector (e.g., a sub-pixel or integer pixel precision) for the block in the case of inter-prediction.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector prediction (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block (s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the prediction unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

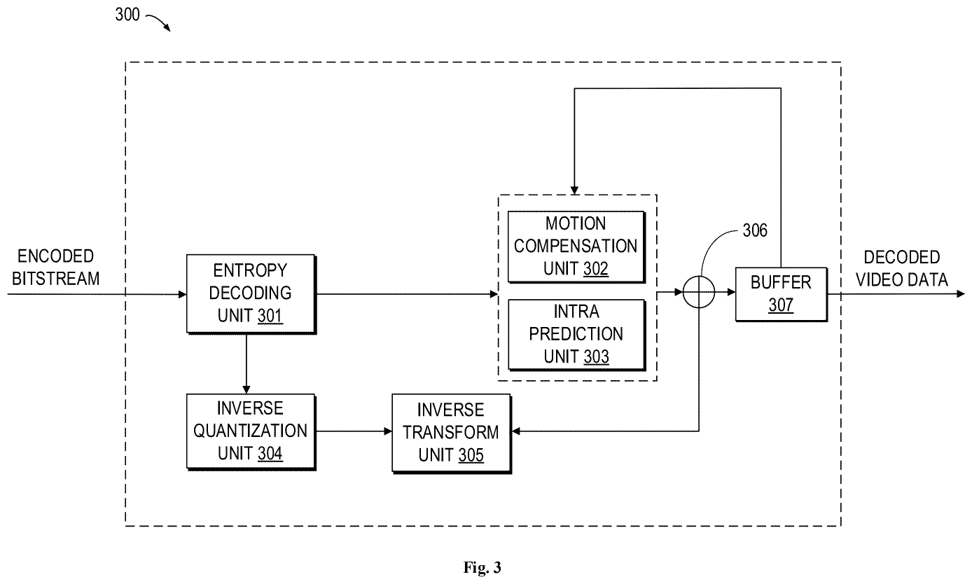

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra prediction and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Brief Summary

This disclosure is related to video coding technologies. Specifically, it is related to the loop filter in image/video coding. It may be applied to the existing video coding standard like High-Efficiency Video Coding (HEVC), Versatile Video Coding (VVC), or the standard (e.g., AVS3) to be finalized. It may be also applicable to future video coding standards or video codec or being used as post-processing method which is out of encoding/decoding process.

### 2. Introduction

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, Joint Video Exploration Team (JVET) was founded by VCEG and MPEG jointly in 2015. Since then, many new methods have been adopted by NET and put into the reference software named Joint Exploration Model (JEM). In April 2018, the Joint Video Expert Team (JVET) between VCEG (Q6/16) and ISO/IEC JTC1 SC29/WG11 (MPEG) was created to work on the VVC standard targeting at 50% bitrate reduction compared to HEVC. VVC version 1 was finalized in July 2020.

The Joint Video Exploration Team (JVET) of ITU-T VCEG and ISO/IEC MPEG is exploring potential neural network video coding technology beyond the capabilities of VVC. The exploration activities are known as neural network-based video coding (NNVC). The neural network-based (NN-based) coding tools are to enhance or replace conventional modules in the existing VVC design. The implementation of NN-based tools in NNVC 4 are based on Small Ad-hoc Deep Learning (SADL) library.

The NNVC-4.0 reference software is provided to demonstrate a reference implementation of encoding techniques and the decoding process, as well as the training methods for neural network-based video coding explored in JVET.

### 2.1. Definitions of Video Units

A picture is divided into one or more tile rows and one or more tile columns. A tile is a sequence of CTUs that covers a rectangular region of a picture.

A tile is divided into one or more bricks, each of which consisting of a number of CTU rows within the tile.

A tile that is not partitioned into multiple bricks is also referred to as a brick. However, a brick that is a true subset of a tile is not referred to as a tile.

A slice either contains a number of tiles of a picture or a number of bricks of a tile.

Two modes of slices are supported, namely the raster-scan slice mode and the rectangular slice mode. In the raster-scan slice mode, a slice contains a sequence of tiles in a tile raster scan of a picture. In the rectangular slice mode, a slice contains a number of bricks of a picture that collectively form a rectangular region of the picture. The bricks within a rectangular slice are in the order of brick raster scan of the slice.

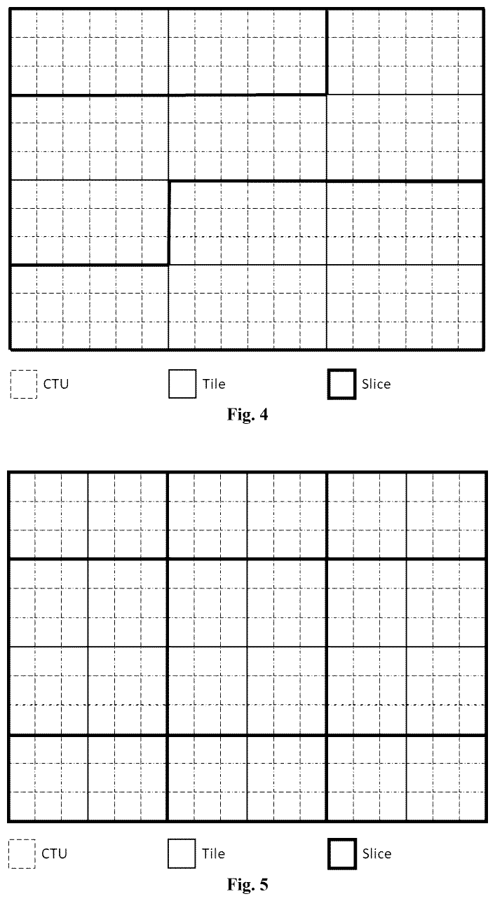

FIG. 4 shows an example of raster-scan slice partitioning of a picture, where the picture is divided into 12 tiles and 3 raster-scan slices. FIG. 4 shows picture with 18 by 12 luma CTUs that is partitioned into 12 tiles and 3 raster-scan slices (informative).

FIG. 5 illustrates an example of rectangular slice partitioning of a picture, where the picture is divided into 24 tiles (6 tile columns and 4 tile rows) and 9 rectangular slices. FIG. 5 illustrates a picture with 18 by 12 luma CTUs that is partitioned into 24 tiles and 9 rectangular slices (informative).

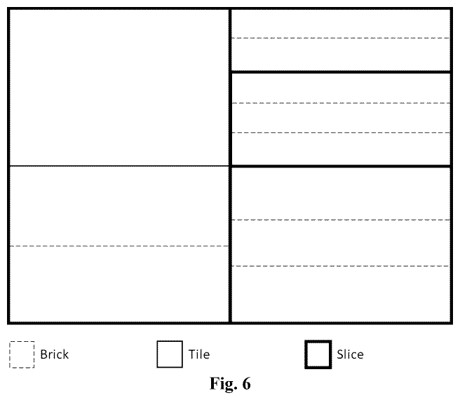

FIG. 6 shows an example of a picture partitioned into tiles, bricks, and rectangular slices, where the picture is divided into 4 tiles (2 tile columns and 2 tile rows), 11 bricks (the top-left tile contains 1 brick, the top-right tile contains 5 bricks, the bottom-left tile contains 2 bricks, and the bottom-right tile contain 3 bricks), and 4 rectangular slices. FIG. 6 illustrates a picture that is partitioned into 4 tiles, 11 bricks, and 4 rectangular slices (informative).

### 2.1.1. CTU/CTB Sizes

In VVC, the CTU size, signaled in SPS by the syntax element log 2_ctu_size_minus2, could be as small as 4×4.

### 2.1.2. CTUs in a Picture

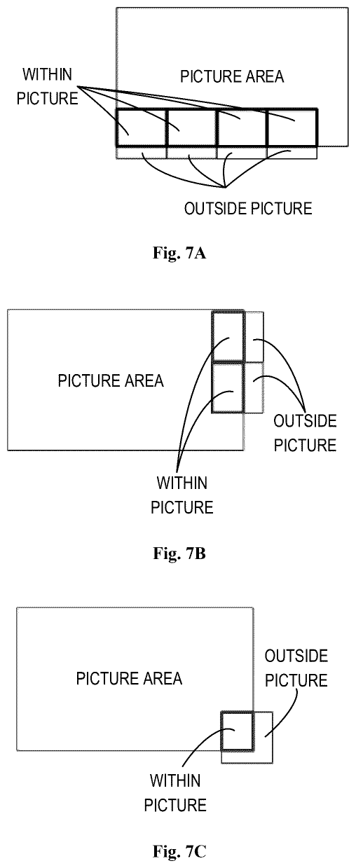

Suppose the CTB/LCU size indicated by M×N (typically M is equal to N, as defined in HEVC/VVC), and for a CTB located at picture (or tile or slice or other kinds of types, picture border is taken as an example) border, K×L samples are within picture border wherein either K<M or L<N. For those CTBs as depicted in FIG. 7A to FIG. 7C, the CTB size is still equal to M×N, however, the bottom boundary/right boundary of the CTB is outside the picture.

FIG. 7A illustrates an example diagram showing CTBs crossing the bottom picture border with K=M, L<N.

FIG. 7B illustrates an example diagram showing CTBs crossing the right picture border with K<M, L=N.

FIG. 7C illustrates an example diagram showing CTBs crossing the right bottom picture border with K<M, L<N.

### 2.2. Coding Flow of a Typical Video Codec

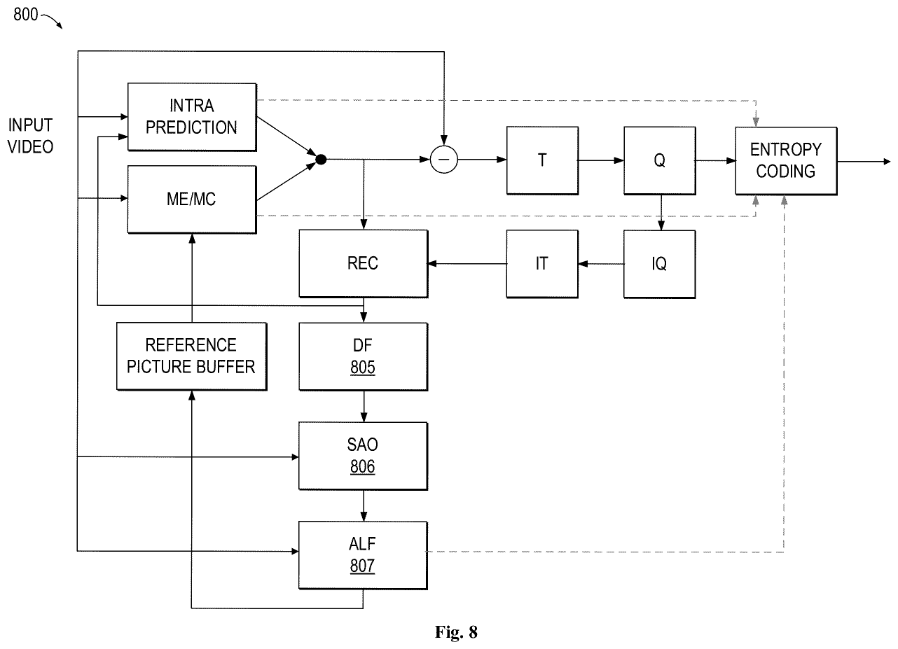

FIG. 8 shows an example of encoder block diagram of VVC, which contains three in-loop filtering blocks: deblocking filter (DF), sample adaptive offset (SAO) and ALF. Unlike DF, which uses predefined filters, SAO and ALF utilize the original samples of the current picture to reduce the mean square errors between the original samples and the reconstructed samples by adding an offset and by applying a finite impulse response (FIR) filter, respectively, with coded side information signaling the offsets and filter coefficients. ALF is located at the last processing stage of each picture and can be regarded as a tool trying to catch and fix artifacts created by the previous stages. FIG. 8 illustrates an example diagram 800 showing an example of encoder block diagram.

### 2.3. Neural Network-Based Video Coding (NNVC)

### 2.3.1. Neural Network-Based Loop Filter Set 0

### 2.3.1.1. Pre-Processing and Post-Processing of Chroma

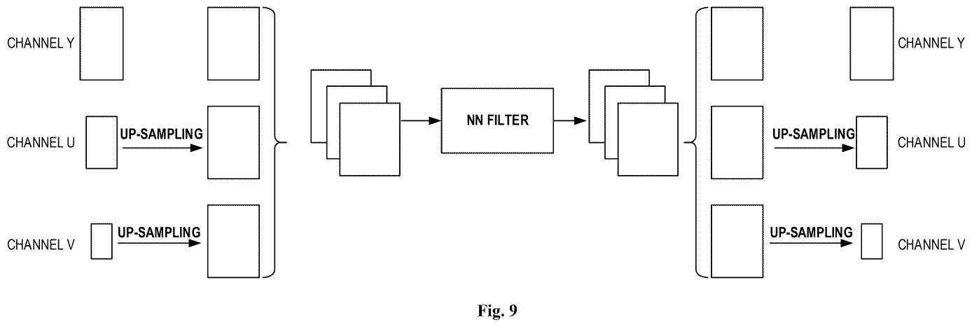

In filter set 0, the filter with a single model is designed to process three components. Since the resolutions of luma and chroma are different, pre-processing and post-processing steps are introduced to up-sample and down-sample chroma components respectively as shown in FIG. 9. In the resampling process, the nearest-neighbor interpolation method is used. FIG. 9 illustrates the pre-processing and post-processing units.

### 2.3.1.2. Neural Network

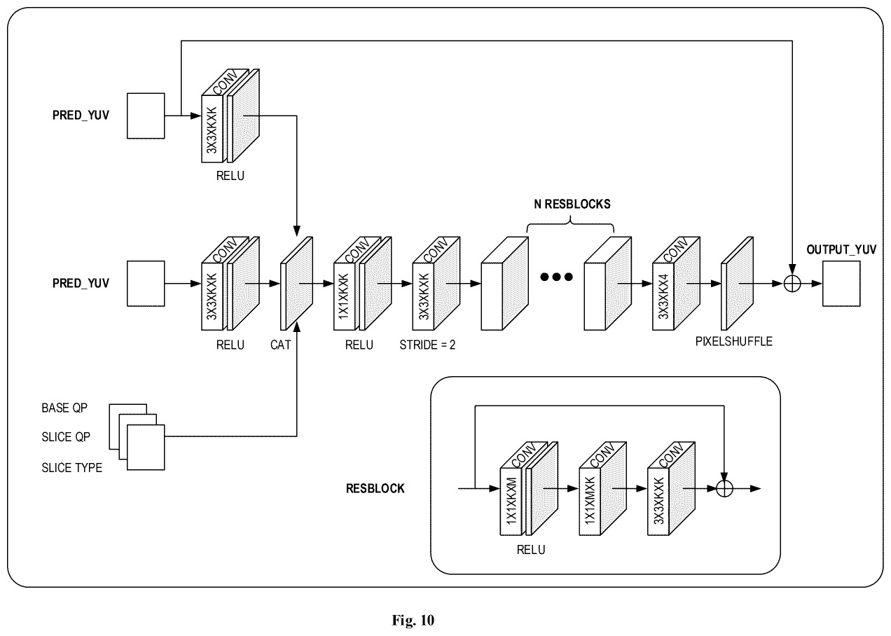

The network structure of the CNN filter is shown in FIG. 10. Along with the reconstructed image (rec_yuv), additional side information is also fed into the network, such as the prediction image (pred_yuv), slice QP, base QP and slice type. In the ResBlock, the number of channels firstly goes up before the activation layer, and then goes down after the activation layer. Specifically, K and M are set to 64 and 160 respectively, and the number of Resblock is set to 32. FIG. 10 illustrates architecture of the CNN in filter set 0.

2.3.1.3. Combination with Conventional Filters

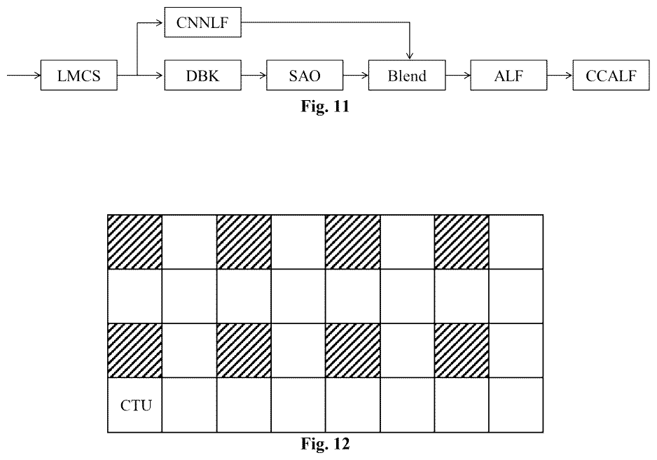

FIG. 11 illustrates an implementation of the CNN in filter set 0. As shown in FIG. 11, the reconstructed samples before DBK are fed into the CNN based filter (CNNLF), then final filtered samples are generated by blending the result of CNNLF and SAO. This blending process can be briefly formulated as:

$${R}_{B l e n d} = w \times {R}_{N N} + ( 1 - w ) \times {R}_{S A O} .$$

There are four candidates, 1, 0.75, 0.5 and an adaptive weight, for the blending weight. With regard to the adaptive weight, its derivation is based on least square method. If the adaptive weight is selected, the blending weight is signaled for each color component in the slice header.

### 2.3.1.4. Mode Selection

The CNN filter can be turned on/off at the CTU level and slice level. For each enabling type, there are four blending ways. Therefore, there are nine modes to be evaluated by RDO at encoder. The final selected mode would be signaled in the slice header.

TABLE 1
Parameter selection of filter set 0

| | | Blending weight |
|---|---|---|
| Mode | On/off type | (w) |
| 0 | Disable at slice level | None |
| 1 | Enable at slice level | Adaptive weight |
| 2 | | 1 |
| 3 | | 0.75 |
| 4 | | 0.5 |
| 5 | Enable at CTU level | Adaptive weight |
| 6 | | 1 |
| 7 | | 0.75 |
| 8 | | 0.5 |

### 2.3.1.5. Base QP Adjustment

Base QP is fed into the CNN filter as shown in FIG. 10. To improve adaptation, an offset can be added to the base QP (the adjusted base QP is used as the input to the NN filter) at slice level. The offset candidates are {−5, 5}. For example given the offset −5, the actual input base QP to the filter becomes (BaseQP−5) for the current slice.

### Encoder Approach

The proposed encoder only filters one out of every four CTUs during the process of selecting the best base QP offset to save encoding time. As shown in FIG. 12, only shaded CTUs are considered for calculating distortions of using different BaseQP candidates {BaseQP, BaseQP-5, BaseQP+5}. After the candidate with the smallest cost is selected, the encoder filters the rest of CTUs (non-shaded ones in FIG. 12) by applying the best offset to the base QP. FIG. 12 illustrates an encoder optimization 2.

### 2.3.1.6. Encoder-Only Optimization

To more accurately estimate the rate-distortion (RD) cost with integrated NN-based in-loop filters, an encoder-only NN filter is involved in the partitioning decision process. In the partitioning mode decision, the distortion between NN filtered samples and original samples is calculated, and then the optimal partitioning mode is selected based on calculated distortion to make the partitioning decision more accurate. To reduce complexity, only few ResBlocks (see Section 2.3.1.2) are used in the network structure. The NN filter in the RDO process is implemented with SADL using int16 precision. This encoder-only NN tool is disabled by default.

### 2.3.1.7. Inference Details

SADL (see Section 2.3.4) is used for performing the inference of the CNN filters. Both floating point-based and fixed point-based implementations are supported. In the fixed-point implementation, both weights and feature maps are represented with int16 precision using a static quantization method. The network information in the inference stage is provided in Table 2.

TABLE 2
Network Information of filter set 0 in Inference Stage
Network Information in Inference Stage

| Mandatory | HW environment: | |
|---|---|---|
| | GPU Type | N/A |
| | Framework: | SADL |
| | Number of GPUs per Task | 0 |
| | Number of Parameters (Each Model) | 1.9M |
| | Total Parameter Number | 1.9M, one model in total |
| | Parameter Precision (Bits) | float: 32 |
| | | int: 16 |
| | Memory Parameter (MB) | float: 7.6 MB, one model in total |
| | | int: 3.8 MB, one model in total |
| | Multiply Accumulate (kMAC/pixel) | 485 (assuming frame-level input) |
| | | 615 (assuming block-level input) |
| Optional | Total Conv. Layers | 101 |
| | Total FC Layers | 0 |
| | Total Memory (MB) | |
| | Batch size: | 1 |
| | Patch size | 144 × 144 |
| | Changes to network configuration or weights | |
| | required to generate rate points | |
| | Peak Memory Usage | |
| | Other information: | |

### 2.3.2. Neural Network-Based Loop Filter Set 1

### 2.3.2.1. Neural Network for Luma Component

There are two regular networks in filter set 1, one for luma and one for chroma.

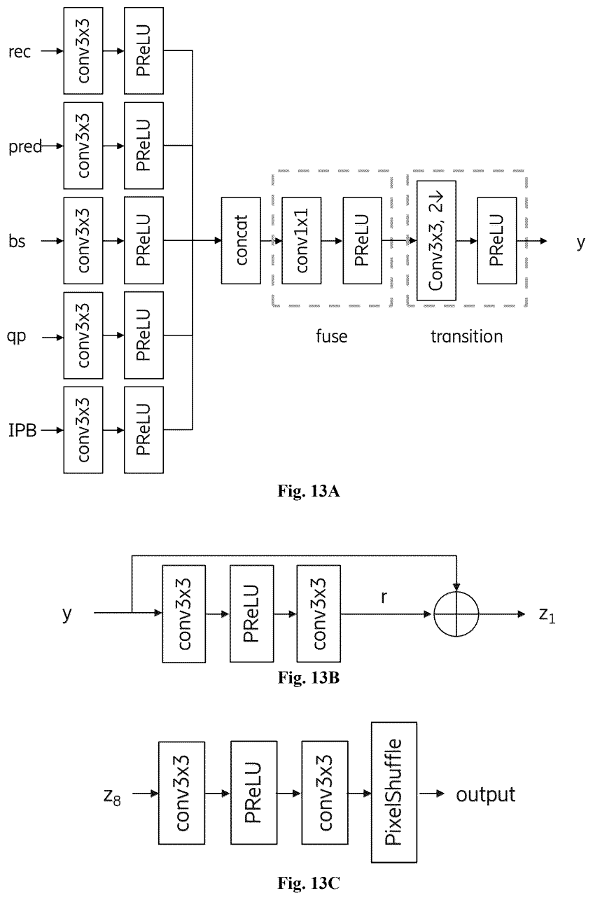

The inputs of the luma network comprise the reconstructed luma samples (rec), the prediction luma samples (pred), boundary strengths (bs), QP, and the block type (IPB). The numbers of feature maps and residual blocks are set as 96 and 8 respectively. The structure of the luma network is depicted in FIG. 13A to FIG. 13C.

FIG. 13A to FIG. 13C illustrate architecture of the CNN in filter set 1, respectively. FIG. 13A shows a head of luma network. The inputs are combined to form the input y to the next part of the network. FIG. 13B shows the k-th residual block (k=0 . . . 7). The output y of the head is fed into a first residual block with input z₀=y. The output z₁ is then fed into another such residual block. FIG. 13C shows the output of the last residual block is fed into this last part of the network.

### 2.3.2.2. Neural Network for Chroma Component

Luma information is taken as additional input for the in-loop filtering of chroma. Considering the resolution of luma is higher than chroma in YUV 4:2:0 format, features are first extracted separately from luma and chroma. Then luma features are down-sampled and concatenated with chroma features. The inputs of the chroma network include reconstructed luma samples (recY), reconstructed chroma samples (recUV), predicted chroma samples (predUV), boundary strength (bsUV), and QP. Regarding network backbone, chroma components use the same one as luma.

### 2.3.2.3. Temporal Filter

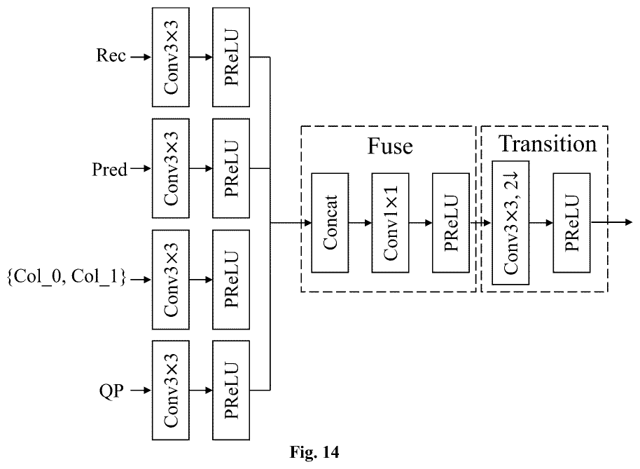

Filter set 1 contains an additional in-loop filter, namely temporal fitter, which takes collocated blocks from the first picture in both reference picture lists to improve performance. The two collocated blocks are directly concatenated and fed into the network as shown in FIG. 14. When enabling temporal filtering feature, the temporal filter is applied to the luma component of pictures in three highest temporal layers, while the regular luma and chroma filters are used for other cases. By default, this temporal filtering feature is disabled.

FIG. 14 shows a temporal in-loop filter. Only head part is illustrated, other parts remain the same as in FIG. 13B to FIG. 13C. {Col 0, Col 1} refers to collocated samples from the first picture in both reference picture lists.

### 2.3.2.4. Adaptive Inference Granularity

The granularity of the filter determination and the parameter selection is dependent on resolution and QP. Given a higher resolution and a larger QP, the determination and selection will be performed in a larger region.

### 2.3.2.5. Parameter Selection

Each slice or block could determine whether to apply the CNN-based filter or not. When the CNN-based filter is determined to be applied to a slice/block, which conditional parameter from a candidate list including three candidates derived from QP could be further decided. Denote the sequence level QP as q, the candidate list includes conditional parameters {Param_1, Param_2, Param_3}. For low temporal layers, Param_1=q, Param_2=q−5, Param_3=q−10. For high temporal layers, Param_1=q, Param_2=q−5, Param_3=q+5. In other words, the third candidate is different across different temporal layers.

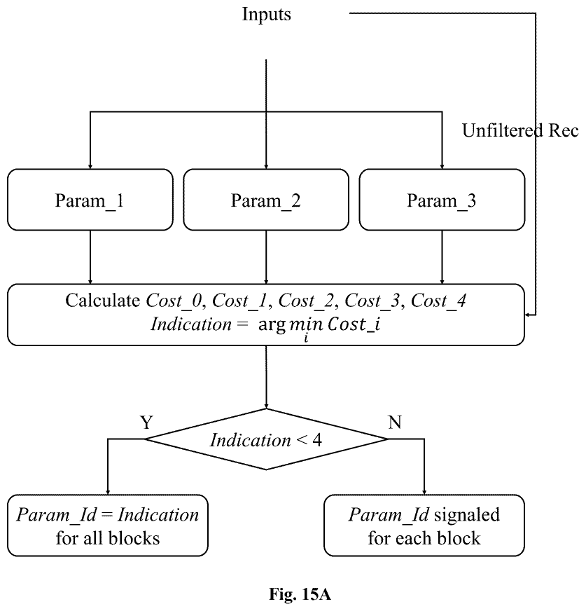

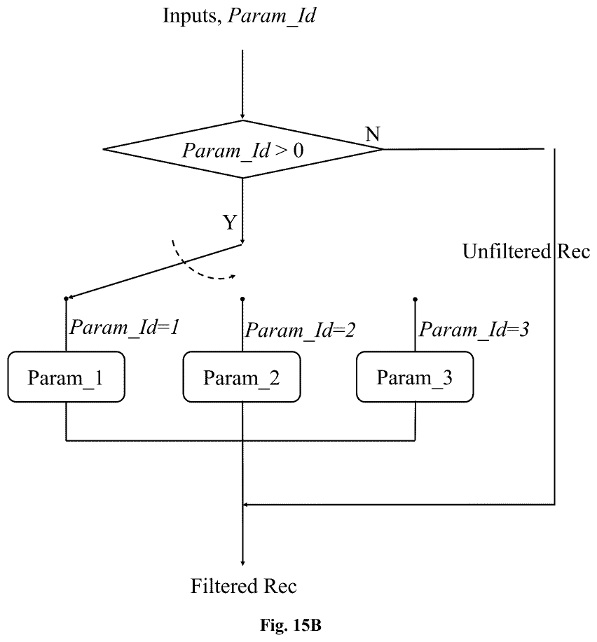

The selection process is based on the rate-distortion cost at the encoder side. Indication of on/off control as well as the conditional parameter index, if needed, are signalled in the bitstream. FIG. 15A and FIG. 15B shows the diagram of parameter selection at encoder and decoder sides. All blocks in the current frame need to be processed with three conditional parameters first. Then five costs, i.e. Cost_0, . . . , Cost_5, are calculated and compared against each other to achieve optimum rate-distortion performance. In Cost_0, CNN-based filter is prohibited for all blocks. In Cost_i, {i=1, 2, 3}, the parameter Param_i is used for all blocks. In Cost 4, different blocks may prefer different parameters, and the information regarding whether to use CNN-based filter or which parameter to be used is signaled for each block. At decoder side, whether to use CNN-based filter or which parameter to be used for a block is based on the Param_Id parsed from the bit-stream as shown in FIG. 15B.

Note that for all-intra configuration, parameter selection is disabled while filter on/off control is still preserved. A shared conditional parameter is used for the two chroma components to ease the burden in worst case at decoder side. In addition, the max number of conditional parameter candidates could be specified at encoder side.

### 2.3.2.6. Residue Scaling

When a NN filter is being applied to reconstructed pictures, a scaling factor is derived and signaled for each color component in the slice header. The derivation is based on least square method. The difference between the input samples and the NN filtered samples (residues) are scaled by the scaling factors before being added to input samples.

2.3.2.7. Combination with Deblocking Filter

To enable a combination with deblocking, the input samples used in the residual scaling is the output of deblocking filtering. The residual scaling process is shown below, where R_{NN} and R_{DB} refer to the outputs of NN filtering and deblocking filtering respectively.

$${R}_{Refine} = ( {R}_{N N} - {R}_{D B} ) \times w + {R}_{D B} = w \times {R}_{N N} + ( 1 - w ) \times {R}_{D B} .$$

### 2.3.2.8. Encoder-Only Optimization

Different from NNVC-2.0, EncDbOpt is also enabled for AI configuration.

For a better estimation of rate-distortion (RD) cost in the case the NN filter is used, the proposed encoder introduces NN-based filtering into the rate-distortion optimization (RDO) process of partitioning mode selection. Specifically, a refined distortion is calculated by comparing the NN filtered samples and the original samples. The partitioning mode with the smallest rate-refined distortion cost is selected as the optimal one. To reduce complexity, several fast algorithms are applied. First, NN model is simplified by using a less number of residual blocks. Second, parameter selection is not allowed for the NN filtering in the RDO process Third, the proposed technique is only applied to the coding units with height and width no larger than 64. The NN filter used in the RDO process is also implemented with SADL using fixed point-based calculation. This NN-based encoder-only method is disabled by default.

### 2.3.2.9. Inference Details

SADL (see Section 2.3.4) is used for performing the inference of the CNN filters. Both floating point-based and fixed point-based implementations are supported. In the fixed-point implementation, both weights and feature maps are represented with int16 precision using a static quantization method. The network information in the inference stage is provided in Table 3.

TABLE 3
Network Information of filter set 1 in Inference Stage
Network Information in Inference Stage

| Mandatory | HW environment: | |
|---|---|---|
| | GPU Type | N/A |
| | Framework: | SADL |
| | Number of GPUs per Task | 0 |
| | Total Parameter Number | 1.55M/model, 2 models in total for all |
| | | tests |
| | Parameter Precision (Bits) | float: 32 |
| | | int: 16 |
| | Memory Parameter (MB) | float: 6.2 MB/model, 2 models |
| | | int: 3.1 MB/model, 2 models |
| | Multiply Accumulate (kMAC/pixel) | 532 (assuming frame-level input) |
| | | 673 (assuming block-level input) |
| Optional | Total Conv. Layers | 25 |
| | Total FC Layers | 0 |
| | Total Memory (MB) | |
| | Batch size: | 1 |
| | Patch size | 144 × 144, 272 × 272 |
| | Changes to network configuration or | |
| | weights required to generate rate points | |
| | Peak Memory Usage | |
| | Other information: | |

### 2.3.3. Neural Network-Based Intra Prediction

### 2.3.3.1. Neural Network Inference

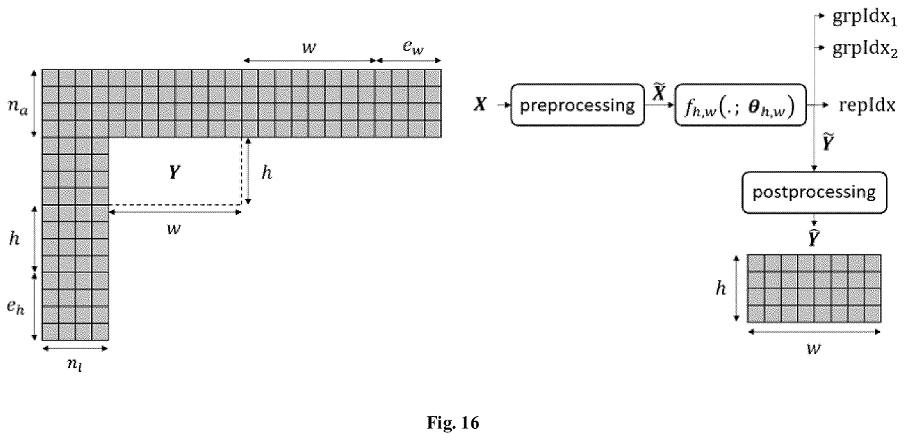

The neural network-based intra prediction mode contains 7 neural networks, each predicting blocks of a different size in {4×4, 8×4, 16×4, 32×4, 8×8, 16×8, 16×16}. The neural network predicting blocks of size w×h is denoted f_{h,w}(., θ_{h,w}) where θ_{h,w} gathers its parameters. For a given w×h block Y, f_{h,w}(., θ_{h,w}) takes a preprocessed version \tilde{X} of the context X made of nₐ rows of nₗ+2w+e_{w} reference samples located above this block and nₗ columns of 2h+eₕ reference samples on its left side to provide \tilde{Y}. The application of a postprocessing to \tilde{Y} yields a prediction Ŷ of Y, see FIG. 16. Besides, f_{h,w}(., θ_{h,w}) returns two indices grpIdx₁ and grpIdx₂. grpIdxᵢ denotes the index characterizing the LFNST kernel index and whether the primary transform coefficients resulting from the application of the DCT-2 horizontally and the DCT-2 vertically to the residue of the neural network prediction are transposed when lfnstIdx=i, i∈{1, 2}, see FIG. 16. Furthermore, f_{h,w}(., θ_{h,w}) gives the index repIdx∈[[0,66]] of the VVC intra prediction mode (PLANAR or DC or directional intra prediction mode) whose prediction of Y from the reference samples surrounding Y best represents Ŷ, see FIG. 16. FIG. 16 shows prediction of the current w×h block Y from the context X of reference samples around Y via the neural network-based intra prediction mode. Here, w=8 and h=4.

If min(h,w)≤8 && hw<256:

```
  nₐ = nₗ = min(h, w)
otherwise:
  if h > 8:
      nₐ = h/2
  otherwise:
    nₐ = h
  if w > 8:
    nₗ = w/2
  otherwise:
    nₗ = w.
If h ≤ 8, eₕ = 4. Otherwise, eₕ = 0.
If w ≤ 8, e_{w} = 4. Otherwise, e_{w} = 0.
```

### 2.3.3.2. Preprocessing and Postprocessing

### 2.3.3.2.1. Preprocessing of the Context of the Current Block

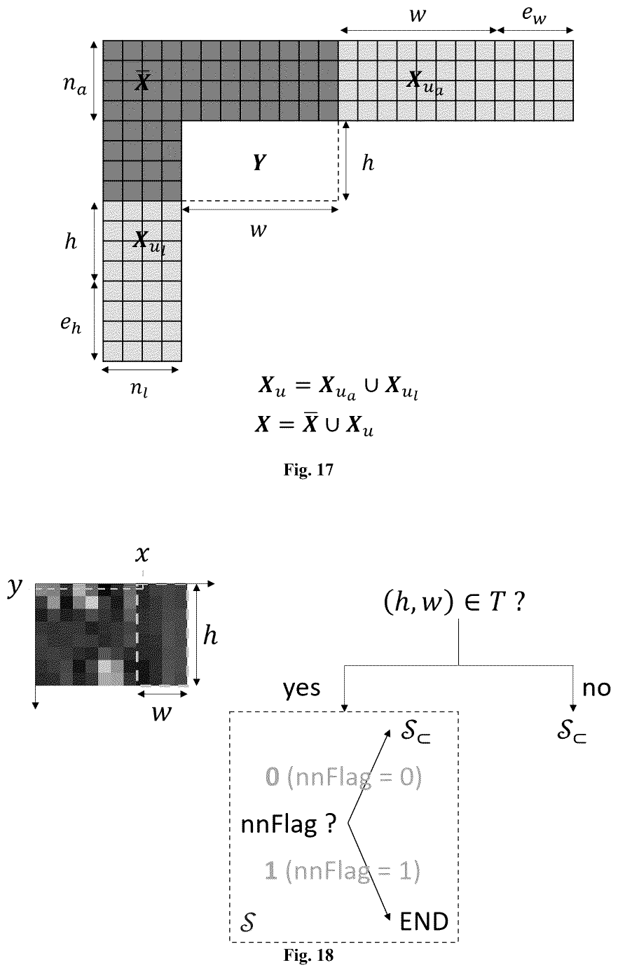

The “preprocessing” shown in FIG. 16 consists in the four following steps.
The mean μ of the available reference samples X̅ in X, see FIG. 17, is subtracted from X̅.
If the neural network predicting the current block is in floats, the reference samples in the context X are multiplied by ρ=1/(2^{b-8}), b being the internal bitdepth, i.e. 10 in VVC. Otherwise, the reference samples in the context X are multiplied by ρ=2^{Q}^{ᵢₙ}^{-b+8}, Qᵢₙ denoting the input quantizer.
All the unavailable reference samples Xᵤ in X, see FIG. 17, are set to 0.
The context resulting from the previous step is flattened, yielding \tilde{X}, a vector of size nₐ(nₗ+2w+e_{w})+(2h+eₕ)nₗ.

FIG. 17 shows decomposition of the context X of reference samples surrounding the current w×h block Y into the available reference samples X̅ and the unavailable reference samples Xᵤ. Here, w=8 and h=4. In the illustrated case, the number of unavailable reference samples reaches its maximum value.

### 2.3.3.2.2. Postprocessing of the Neural Network Prediction

The “postprocessing” depicted in FIG. 16 consists in reshaping the vector \tilde{Y} of size hw into a rectangle of height h and width w, dividing the result of the reshape by ρ, adding the mean μ of the available reference samples in the context of the current block, and clipping to [0, 2^{b}−1]. Therefore, the postprocessing can be summarized as

$$\hat{Y} = min ( max ( \frac{reshape ( \tilde{Y} )}{ρ} + μ , 0 ) , {2}^{b} - 1 ) .$$

### 2.3.3.3. Adaptation of the Derivation of the List of MPMs

When creating the MPM list of a given luma CB, if the “left” luma CB is predicted via the neural network-based intra prediction mode, the neural network-based mode index can be replaced by the repIdx returned during the prediction of the “left” luma CB and become a candidate index to be put into the MPM list. Similarly, if “above” luma CB is predicted via the neural network-based intra prediction mode, the neural network-based mode index can be replaced by the repIdx returned during the prediction of the “above” luma CB and become a candidate index to be inserted into the MPM list.

### 2.3.3.4. Signaling of the Neural Network-Based Intra Prediction Mode

### 2.3.3.4.1. Signaling of the Neural Network-Based Intra Prediction Mode in Luma

For the current w×h luma CB whose top-left pixel is at position (y, x) in the current luma channel, the intra prediction mode signaling in luma is split into two cases.
If (h, w)∈T, nnFlag appears in the intra prediction mode signaling in luma. nnFlag=1 means that the neural network-based intra prediction mode is selected to predict the current luma CB and END. nnFlag=0 means that the neural network-based intra prediction mode is not selected to predict the current luma CB, then the regular intra prediction mode signaling in luma, denoted S_{⊂} applies, see FIG. 18.
Otherwise, the regular intra prediction mode signaling in luma S_{⊂} applies.

Note that, in the case “(h, w)∈T && nnFlag=1”, if the context of the current luma CB goes out of the bounds of the current luma channel, i.e. x<nₗ∥y<nₐ, the neural network-based intra prediction is replaced by PLANAR.

$$T = \{ ( 4 , 4 ) , ( 4 , 8 ) , ( 8 , 4 ) , ( 4 , 16 ) , ( 16 , 4 ) , ( 4 , 32 ) , ( 32 , 4 ) , ( 8 , 8 ) , ( 8 , 16 ) , ( 16 , 8 ) , ( 8 , 32 ) , ( 32 , 8 ) , ( 16 , 16 ) , ( 16 , 32 ) , ( 32 , 16 ) , ( 32 , 32 ) , ( 64 , 64 ) \} .$$

FIG. 18 shows intra prediction mode signaling for the current w×h luma CB framed in orange in dashed line. The coordinates of the pixel at the top-left of this CB are (y, x). The bin value of a nnFlag value appears in bold gray. Here, h=8, w=4, x=8, and y=0.

### 2.3.3.4.2. Signaling of the Neural Network-Based Intra Prediction Mode in Chroma

For the current w×h chroma CB whose top-left pixel is at position (y, x) in the current chroma channel, the intra prediction mode signaling in chroma is split into two cases.
If the luma CB collocated with this chroma CB is predicted by the neural network-based intra prediction mode:
   If (h, w)∈T, the DM becomes the neural network-based intra prediction mode.
   Otherwise, the DM is set to PLANAR
Otherwise:
   If (h, w)∈T, nnFlagChroma appears in the intra prediction mode signaling in chroma. nnFlagChroma is placed before the DM flag in the decision tree of the intra prediction mode signaling in chroma. nnFlagChroma=1 means that the neural network-based intra prediction mode is selected to predict the current pair of chroma CBs and END. nnFlagChroma=0 means that the neural network-based intra prediction mode is not selected to predict the current pair of chroma CBs, then the regular intra prediction mode signaling in chroma resumes from the DM flag.
Otherwise, the regular intra prediction mode signaling in chroma applies.

Note that, in the case where “(h, w)∈T and the DM becomes the neural network-based intra prediction mode” and the case where “(h, w)∈T && nnFlagChroma=1”, if the context of the current chroma CB goes out of the bounds of the current chroma channel, i.e. x<nₗ∥y<nₐ, the neural network-based intra prediction is replaced by PLANAR

### 2.3.3.5. Transformation of the Context and the Neural Network Prediction

For a given w×h block, if (h, w)∈T, it is possible that the neural network-based intra prediction mode must predict this block but the neural network-based intra prediction mode does not contain f_{h,w}(., θ_{h,w}). In this case, the context of the current block can be down-sampled vertically by a factor δ and/or down-sampled horizontally by a factor γ and/or transposed before the step called “preprocessing” in FIG. 16. Then, the prediction of the current block can be transposed and/or up-sampled vertically by the factor δ and/or up-sampled horizontally by the factor γ after the step called “postprocessing” in FIG. 16. The transposition of the context of the current block and the prediction, δ, and γ are chosen so that a neural network belonging to the neural network-based intra prediction mode is used for prediction, see Table 4.

TABLE 4
decision of transposing the context of the current w × h block to be
predicted and the prediction of this block, the value of γ, and the
value of δ, and the neural network belonging to the neural network-based
intra prediction mode used for prediction for each (h, w) ϵ T.

| height and width | | | | neural network |
|---|---|---|---|---|
| of the block | | | trans- | used for |
| to be predicted (h, w) | γ | δ | position | prediction |
| (4, 4) | 1 | 1 | no | θ_{4,4}(.,θ_{4,4}) |
| (4, 8) | 1 | 1 | no | ƒ_{4,8}(.,θ_{4,8}) |
| (8, 4) | 1 | 1 | yes | ƒ_{4,8}(.,θ_{4,8}) |
| (4, 16) | 1 | 1 | no | ƒ_{4,16}(.,θ_{4,16}) |
| (16, 4) | 1 | 1 | yes | ƒ_{4,16}(.,θ_{4,16}) |
| (4, 32) | 1 | 1 | no | ƒ_{4,32}(.,θ_{4,32}) |
| (32, 4) | 1 | 1 | yes | ƒ_{4,32}(.,θ_{4,32}) |
| (8, 8) | 1 | 1 | no | ƒ_{8,8}(.,θ_{8,8}) |
| (8, 16) | 1 | 1 | no | ƒ_{8,16}(.,θ_{8,16}) |
| (16, 8) | 1 | 1 | yes | ƒ_{8,16}(.,θ_{8,16}) |
| (8, 32) | 2 | 1 | no | ƒ_{8,16}(.,θ_{8,16}) |
| (32, 8) | 1 | 2 | yes | ƒ_{8,16}(.,θ_{8,16}) |
| (16, 16) | 1 | 1 | no | ƒ_{16,16}(.,θ_{16,16}) |
| (16, 32) | 2 | 1 | no | ƒ_{16,16}(.,θ_{16,16}) |
| (32, 16) | 1 | 2 | no | ƒ_{16,16}(.,θ_{16,16}) |
| (32, 32) | 2 | 2 | no | ƒ_{16,16}(.,θ_{16,16}) |
| (64, 64) | 4 | 4 | no | ƒ_{16,16}(.,θ_{16,16}) |

### 2.3.4. Small Ad-Hoc Deep Learning (SADL) Library

SADL (Small Ad-hoc Deep-Learning Library) is a header only small library for inference of neural networks. SADL provides both floating-point-based and integer-based inference capabilities. The inference of neural networks in NNVC is based on the SADL.

Table 5 below summarizes the framework characteristics.

TABLE 5
Characteristics of SADL

| | |
|---|---|
| Language | Pure C++, header only. |
| Footprint | ~6000 LOC, library ~300 kB, no dependency |
| Optimization | Some SIMD at hot spots, e.g. convolution |
| | (conv2D) and automatic sparse matrix- |
| | vector multiplication |
| Compatibility | Onnx to SADL converter |
| Layer Supports | constants, add, maxPool, matMul (dense and sparse), |
| | reshape, ReLU, conv2D (strided, grouped, separated), |
| | mul, concat, max, leakyReLU, shape, |
| | expand, PRELU, flatten,transpose, |
| | Cond2DTranspose, Slicing |
| Type support | float, int32, int16, int8 |
| Quantization | Support adaptive quantizer per layer |
| License | BSD 3-Clause |

NNVC repository uses SADL as a submodule, pointing to the repository here: https://vcgit.hhi.fraunhofer.de/jvet-ahg-nnvc/sadl.

Documentation is available in the doc directory of the repository.

### 3. Problems

The current NN-based loop filtering in NNVC has the following problems:
1. Output of intermediate layers is not normalized.
2. The non-linear activation functions, such as ReLU (Rectified Linear Init), PReLU (Parametric Rectified Linear Unit), LReLU (Leaky Rectified Linear Activation), etc., may be suboptimal.
3. The vanilla convolutional layer obtains an element in an output channel by involving the corresponding elements in all input channels, causing high computational complexity.
4. There is no attention mechanism in the NN filter.

### 4. Detailed Solutions

The detailed embodiments below should be considered as examples to explain general concepts. These embodiments should not be interpreted in a narrow way. Furthermore, these embodiments can be combined in any manner.

One or more neural network (NN) filter models are trained as part of an in-loop filtering technology or filtering technology used in a post-processing stage for reducing the distortion incurred during compression. Samples with different characteristics are processed by different NN filter models or a NN filter model with different parameters. This disclosure elaborates how to improve and optimize the architecture for NN filter.

It should be noted that the improvement and optimization on the neural network architecture could be also extended to other NN-based coding tools, such as NN-based intra prediction, NN-based cross component prediction, NN-based inter prediction, NN-based super-resolution, NN-based motion compensation, NN-based reference frame generation, NN-based transform design. In the examples below, we use NN-based filtering technology as an example.

In the disclosure, a NN filter can be any kind of NN filter, such as a convolutional neural network (CNN) filter, fully connected neural network filter, transformer-based filter, recurrent neural network-based filter. In the following discussion, a NN filter may also be referred to as a CNN filter.

In the following discussion, a video unit may be a sequence, a picture, a slice, a tile, a brick, a subpicture, a CTU/CTB, a CTU/CTB row, one or multiple CUs/CBs, one ore multiple CTUs/CTBs, one or multiple VPDU (Virtual Pipeline Data Unit), a sub-region within a picture/slice/tile/brick. A father video unit represents a unit larger than the video unit. Typically, a father unit will contain several video units. E.g., when the video unit is CTU, the father unit could be slice, CTU row, multiple CTUs, etc.
1. To solve problem 1, the output of intermediate layers in a NN filter may be normalized with layer normalization.
   a. In one example, layer normalization is conducted for each channel in the output of intermediate layers.
2. To solve problem 2, a NN filter may utilize other gate functions in addition to the existing non-linear activation functions.
   a. In one example, the gating function works by directly dividing the feature map into two parts in the channel dimension and multiplying them.
3. To solve problem 3, a NN filter may include depth-wise convolutional layer or group convolutional layer besides the existing vanilla convolutional layers.
   a. In one example, a NN filter includes depth-wise convolutional layer, where an element in an output channel is computed by only involving the corresponding elements in the corresponding input channel.
   b. In one example, a NN filter includes group convolutional layer, where an element in an output channel is computed by only involving the corresponding elements in the certain input channels (instead of all input channels).
4. To solve problem 4, attention may be integrated into the NN filter.
   a. In one example, the channel attention is computed from an output of an intermediate layer in a NN filter and then used to recalibrate the output. Denote the output of an intermediate layer in a NN filter as G∈R^{N×W×H}, where N, W, and H are the channel numbers, width, and height respectively. Let A∈R^{N} represent the attention computed from G.
      i. In one example, A is obtained by first squeezing the spatial information of G into channels and then scale the channels with a vector, i.e. A=W×pool(G) where W∈R^{N} is a weighting vector.
      ii. In one example, the process of applying the attention could be written as: φ^{i,j,k}=G^{i,j,k}×Aⁱ, 1≤i≤N, 1≤j≤W, 1≤k≤H, where φ is the recalibrated feature maps.
      iii. In one example, the process of applying the attention could be written as: φ^{i,j,k}=G^{i,j,k}×f(Aⁱ), 1≤i≤N, 1≤j≤W, 1≤k≤H, where φ is the recalibrated feature maps, f stands for a mapping function applied on each element of the attention, e.g. sigmoid, tan h, etc.
         1) In one example, for different channels of feature maps, different A and/or different f may be used.
      iv. In one example, the process of applying the attention could be written as: φ^{i,j,k}=G^{i,j,k}×f(Aⁱ)+G^{i,j,k}, 1≤i≤N, 1≤j≤W, 1≤k≤H, where φ is the recalibrated feature maps, f stands for a mapping function applied on each element of the attention, e.g. sigmoid, tan h, etc.
         1) In one example, for different channels of feature maps, different A and/or different f may be used.
      v. In one example, the attention operation may be applied to specified layers inside the NN filter.

As used herein, the term “machine learning model” can also be referred to as a “machine learning model”. The machine learning model may comprise any kinds of model, such as a neural network (NN) model (also referred to as a “NN filter” or “NN filter model”), a convolutional neural network (CNN) model, or the like. Alternatively, in some embodiments, the machine learning model further comprises non-NN based models or non-NN based filters. Scope of the present disclosure is not limited in this regard.

As used herein, the term “video unit” or “video block” may be a sequence, a picture, a slice, a tile, a brick, a subpicture, a coding tree unit (CTU)/coding tree block (CTB), a CTU/CTB row, one or multiple coding units (CUs)/coding blocks (CBs), one ore multiple CTUs/CTBs, one or multiple Virtual Pipeline Data Unit (VPDU), a sub-region within a picture/slice/tile/brick. As used herein, the term “father video unit” may represent a unit larger than the video unit. A father unit will contain several video units. For example, if the video unit is a CTU, the father unit may be a slice, CTU row, multiple CTUs, etc.

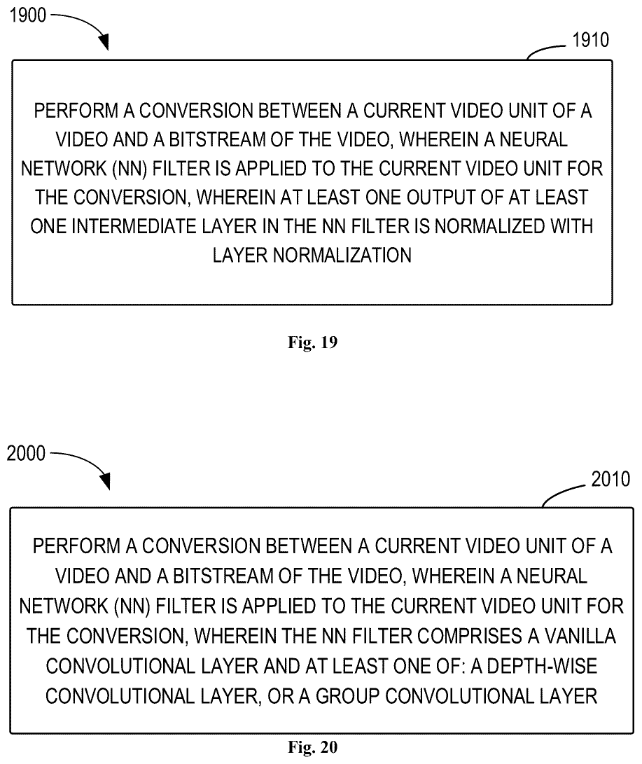

FIG. 19 illustrates a flowchart of a method 1900 for video processing in accordance with embodiments of the present disclosure. The method 1900 is implemented during a conversion between a video unit of a video and a bitstream of the video.

At block 1910, a conversion between a current video unit of a video and a bitstream of the video is performed. A neural network (NN) filter (also referred to as a “NN-based filter” or “filter”) is applied to the current video unit for the conversion. At least one output of at least one intermediate layer in the NN filter is normalized with layer normalization.

In some embodiments, the conversion includes encoding the current video unit into the bitstream. Alternatively, or in addition, in some embodiments, the conversion includes decoding the current video unit from the bitstream.

The method 1900 enables normalizing the intermediate layers of the NN filter. The coding efficiency can thus be improved.

In some embodiments, the layer normalization is conducted for each channel in the at least one output of the at least one intermediate layer.

According to further embodiments of the present disclosure, a non-transitory computer-readable recording medium is provided. The non-transitory computer-readable recording medium stores a bitstream of a video which is generated by a method performed by an apparatus for video processing. In the method, the bitstream of the video is generated from a current video unit of the video. A NN filter is applied to the current video unit of the video. At least one output of at least one intermediate layer in the NN filter is normalized with layer normalization.

According to still further embodiments of the present disclosure, a method for storing bitstream of a video is provided. In the method, the bitstream of the video is generated from a current video unit of the video. A NN filter is applied to the current video unit of the video. At least one output of at least one intermediate layer in the NN filter is normalized with layer normalization. The bitstream is stored in a non-transitory computer-readable recording medium.

FIG. 20 illustrates a flowchart of a method 2000 for video processing in accordance with embodiments of the present disclosure. The method 2000 is implemented during a conversion between a video unit of a video and a bitstream of the video.

At block 2010, a conversion between a current video unit of a video and a bitstream of the video is performed. A NN filter is applied to the current video unit for the conversion. The NN filter comprises a vanilla convolutional layer and at least one of: a depth-wise convolutional layer, or a group convolutional layer. That is, a NN filter may include depth-wise convolutional layer or group convolutional layer besides the existing vanilla convolutional layers.

In some embodiments, the conversion includes encoding the current video unit into the bitstream. Alternatively, or in addition, in some embodiments, the conversion includes decoding the current video unit from the bitstream.

The method 2000 enables applying the depth-wise or group convolutional layer for the NN filter. The computational complexity can thus be reduced. The coding efficiency can thus be improved.

In some embodiments, the NN filter comprises the depth-wise convolutional layer, and an element in an output channel is determined by involving corresponding elements in an input channel corresponding to the output channel.

In some embodiments, the NN filter comprises the group convolutional layer, and an element in an output channel is determined by involving corresponding elements in a plurality of input channels corresponding to the output channel.

In some embodiments, at least one input channel of the NN filter is excluded from the plurality of input channels. That is, an element in an output channel is computed by only involving the corresponding elements in the certain input channels (instead of all input channels).

According to further embodiments of the present disclosure, a non-transitory computer-readable recording medium is provided. The non-transitory computer-readable recording medium stores a bitstream of a video which is generated by a method performed by an apparatus for video processing. In the method, the bitstream of the video is generated from a current video unit of the video. A NN filter is applied to the current video unit of the video. The NN filter comprises a vanilla convolutional layer and at least one of: a depth-wise convolutional layer, or a group convolutional layer.

According to still further embodiments of the present disclosure, a method for storing bitstream of a video is provided. In the method, the bitstream of the video is generated from a current video unit of the video. A NN filter is applied to the current video unit of the video. The NN filter comprises a vanilla convolutional layer and at least one of: a depth-wise convolutional layer, or a group convolutional layer. The bitstream is stored in a non-transitory computer-readable recording medium.

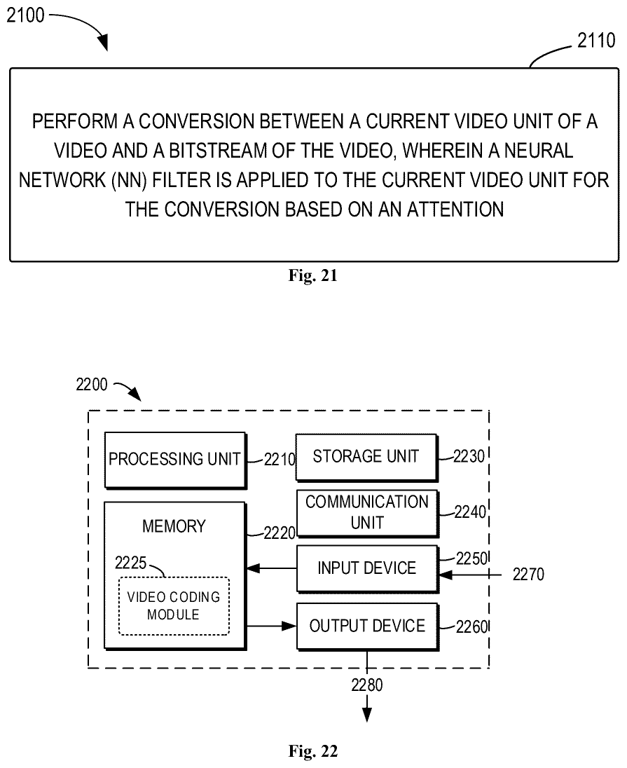

FIG. 21 illustrates a flowchart of a method 2100 for video processing in accordance with embodiments of the present disclosure. The method 2100 is implemented during a conversion between a video unit of a video and a bitstream of the video.

At block 2110, a conversion between a current video unit of a video and a bitstream of the video is performed. A NN filter is applied to the current video unit for the conversion based on an attention.

In some embodiments, the conversion includes encoding the current video unit into the bitstream. Alternatively, or in addition, in some embodiments, the conversion includes decoding the current video unit from the bitstream.

The method 2100 enables applying the attention in the NN filter. The coding efficiency and/or coding effectiveness can thus be improved.

In some embodiments, a channel attention is determined from an output of an intermediate layer in the NN filter, and the channel attention is used to recalibrate the output.

In some embodiments, the channel attention is obtained by squeezing spatial information of the output of the intermediate layer into channels and scaling the channels with a vector.

In some embodiments, the channel attention is determined by A=W×pool(G), where A denotes the channel attention, W∈R^{N} denotes a weighting vector, pool( ) denotes a pooling function, and G∈R^{N×W×H} denotes the output of the intermediate channel, N, W, and H are the channel numbers, width, and height respectively.

In some embodiments, the attention is applied by: φ^{i,j,k}=G^{i,j,k}×Aⁱ, 1≤i≤N, 1≤j≤W, 1≤k≤H, where φ denotes recalibrated feature maps.

In some embodiments, the attention is applied by: φ^{i,j,k}=G^{i,j,k}×f(Aⁱ), 1≤i≤N, 1≤j≤W, 1≤k≤H, where φ denotes recalibrated feature maps, and f denotes a mapping function applied on each element of the attention.

In some embodiments, the attention is applied by: φ^{i,j,k}=G^{i,j,k}×f(Aⁱ)+G^{i,j,k}, 1≤i≤N, 1≤j≤W, 1≤k≤H, where φ denotes recalibrated feature maps, and f denotes a mapping function applied on each element of the attention.

In some embodiments, the mapping function comprises one of: a sigmoid function, or a hyperbolic tangent function (that is, tan h function).

In some embodiments, a first attention for a first channel of feature maps is different from a second attention for a second channel of the feature maps, and/or a first mapping function for the first channel of the feature maps is different from a second mapping function for the second channel of the feature maps.

In some embodiments, the attention is applied to at least one predetermined layer inside the NN filter.

In some embodiments, a gate function (also referred to as a gating function) is utilized by the NN filter in addition to a non-linear activation function.

In some embodiments, the gate function divides a feature map into a plurality of parts in a channel dimension and multiplies the plurality of parts of the feature map.

According to further embodiments of the present disclosure, a non-transitory computer-readable recording medium is provided. The non-transitory computer-readable recording medium stores a bitstream of a video which is generated by a method performed by an apparatus for video processing. In the method, the bitstream of the video is generated from a current video unit of the video. A NN filter is applied to the current video unit of the video based on an attention.

According to still further embodiments of the present disclosure, a method for storing bitstream of a video is provided. In the method, the bitstream of the video is generated from a current video unit of the video. A NN filter is applied to the current video unit of the video based on an attention. The bitstream is stored in a non-transitory computer-readable recording medium.

It is to be understood that the method 1900, the method 2000, and/or the method 2100 can be applied separately, or in any combination.

Implementations of the present disclosure can be described in view of the following clauses, the features of which can be combined in any reasonable manner.

Clause 1. A method for video processing, comprising: performing a conversion between a current video unit of a video and a bitstream of the video, wherein a neural network (NN) filter is applied to the current video unit for the conversion, wherein at least one output of at least one intermediate layer in the NN filter is normalized with layer normalization.

Clause 2. The method of clause 1, wherein the layer normalization is conducted for each channel in the at least one output of the at least one intermediate layer.

Clause 3. A method for video processing, comprising: performing a conversion between a current video unit of a video and a bitstream of the video, wherein a neural network (NN) filter is applied to the current video unit for the conversion, wherein the NN filter comprises a vanilla convolutional layer and at least one of: a depth-wise convolutional layer, or a group convolutional layer.

Clause 4. The method of clause 3, wherein the NN filter comprises the depth-wise convolutional layer, and an element in an output channel is determined by involving corresponding elements in an input channel corresponding to the output channel.

Clause 5. The method of clause 3, wherein the NN filter comprises the group convolutional layer, and an element in an output channel is determined by involving corresponding elements in a plurality of input channels corresponding to the output channel.

Clause 6. The method of clause 5, wherein at least one input channel of the NN filter is excluded from the plurality of input channels.

Clause 7. A method for video processing, comprising: performing a conversion between a current video unit of a video and a bitstream of the video, wherein a neural network (NN) filter is applied to the current video unit for the conversion based on an attention.

Clause 8. The method of clause 7, wherein a channel attention is determined from an output of an intermediate layer in the NN filter, and the channel attention is used to recalibrate the output.

Clause 9. The method of clause 8, wherein the channel attention is obtained by squeezing spatial information of the output of the intermediate layer into channels and scaling the channels with a vector.

Clause 10. The method of clause 9, wherein the channel attention is determined by A=W×pool(G), where A denotes the channel attention, W∈R^{N} denotes a weighting vector, pool( ) denotes a pooling function, and G∈R^{N×W×H} denotes the output of the intermediate channel, N, W, and H are the channel numbers, width, and height respectively.

Clause 11. The method of clause 10, wherein the attention is applied by: φ^{i,j,k}=G^{i,j,k}×Aⁱ, 1≤i≤N, 1≤j≤W, 1≤k≤H, where φ denotes recalibrated feature maps.

Clause 12. The method of clause 10, wherein the attention is applied by: φ^{i,j,k}=G^{i,j,k}×f(Aⁱ), 1≤i≤N, 1≤j≤W, 1≤k≤H, where φ denotes recalibrated feature maps, and f denotes a mapping function applied on each element of the attention.

Clause 13. The method of clause 10, wherein the attention is applied by: φ^{i,j,k}=G^{i,j,k}×f(Aⁱ)+G^{i,j,k}, 1≤i≤N, 1≤j≤W, 1≤k≤H, where φ denotes recalibrated feature maps, and f denotes a mapping function applied on each element of the attention.

Clause 14. The method of clause 12 or 13, wherein the mapping function comprises one of: a sigmoid function, or a hyperbolic tangent function.

Clause 15. The method of clause 12 or 13, wherein a first attention for a first channel of feature maps is different from a second attention for a second channel of the feature maps, and/or a first mapping function for the first channel of the feature maps is different from a second mapping function for the second channel of the feature maps.

Clause 16. The method of any of clauses 7-15, wherein the attention is applied to at least one predetermined layer inside the NN filter.

Clause 17. The method of any of clauses 7-16, wherein a gate function is utilized by the NN filter in addition to a non-linear activation function.

Clause 18. The method of clause 17, wherein the gate function divides a feature map into a plurality of parts in a channel dimension and multiplies the plurality of parts of the feature map.

Clause 19. The method of any of clauses 1-18, wherein the conversion includes encoding the current video unit into the bitstream.

Clause 20. The method of any of clauses 1-18, wherein the conversion includes decoding the current video unit from the bitstream.

Clause 21. An apparatus for video processing comprising a processor and a non-transitory memory with instructions thereon, wherein the instructions upon execution by the processor, cause the processor to perform a method in accordance with any of clauses 1-20.

Clause 22. A non-transitory computer-readable storage medium storing instructions that cause a processor to perform a method in accordance with any of clauses 1-20.

Clause 23. A non-transitory computer-readable recording medium storing a bitstream of a video which is generated by a method performed by an apparatus for video processing, wherein the method comprises: generating the bitstream of the video from a current video unit of the video, wherein a neural network (NN) filter is applied to the current video unit of the video, wherein at least one output of at least one intermediate layer in the NN filter is normalized with layer normalization.

Clause 24. A method for storing a bitstream of a video, comprising: generating the bitstream of the video from a current video unit of the video, wherein a neural network (NN) filter is applied to the current video unit of the video, wherein at least one output of at least one intermediate layer in the NN filter is normalized with layer normalization; and storing the bitstream in a non-transitory computer-readable recording medium.

Clause 25. A non-transitory computer-readable recording medium storing a bitstream of a video which is generated by a method performed by an apparatus for video processing, wherein the method comprises: generating the bitstream of the video from a current video unit of the video, wherein a neural network (NN) filter is applied to the current video unit of the video, wherein the NN filter comprises a vanilla convolutional layer and at least one of: a depth-wise convolutional layer, or a group convolutional layer.

Clause 26. A method for storing a bitstream of a video, comprising: generating the bitstream of the video from a current video unit of the video, wherein a neural network (NN) filter is applied to the current video unit of the video, wherein the NN filter comprises a vanilla convolutional layer and at least one of: a depth-wise convolutional layer, or a group convolutional layer; and storing the bitstream in a non-transitory computer-readable recording medium.

Clause 27. A non-transitory computer-readable recording medium storing a bitstream of a video which is generated by a method performed by an apparatus for video processing, wherein the method comprises: generating the bitstream of the video from a current video unit of the video, wherein a neural network (NN) filter is applied to the current video unit of the video based on an attention.

Clause 28. A method for storing a bitstream of a video, comprising: generating the bitstream of the video from a current video unit of the video, wherein a neural network (NN) filter is applied to the current video unit of the video based on an attention; and storing the bitstream in a non-transitory computer-readable recording medium.

### Example Device

FIG. 22 illustrates a block diagram of a computing device 2200 in which various embodiments of the present disclosure can be implemented. The computing device 2200 may be implemented as or included in the source device 110 (or the video encoder 114 or 200) or the destination device 120 (or the video decoder 124 or 300).

It would be appreciated that the computing device 2200 shown in FIG. 22 is merely for purpose of illustration, without suggesting any limitation to the functions and scopes of the embodiments of the present disclosure in any manner.

As shown in FIG. 22, the computing device 2200 includes a general-purpose computing device 2200. The computing device 2200 may at least comprise one or more processors or processing units 2210, a memory 2220, a storage unit 2230, one or more communication units 2240, one or more input devices 2250, and one or more output devices 2260.

In some embodiments, the computing device 2200 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 2200 can support any type of interface to a user (such as “wearable” circuitry and the like).

The processing unit 2210 may be a physical or virtual processor and can implement various processes based on programs stored in the memory 2220. In a multi-processor system, multiple processing units execute computer executable instructions in parallel so as to improve the parallel processing capability of the computing device 2200. The processing unit 2210 may also be referred to as a central processing unit (CPU), a microprocessor, a controller or a microcontroller.

The computing device 2200 typically includes various computer storage medium. Such medium can be any medium accessible by the computing device 2200, including, but not limited to, volatile and non-volatile medium, or detachable and non-detachable medium. The memory 2220 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 2230 may be any detachable or non-detachable medium and may include a machine-readable medium such as a memory, flash memory drive, magnetic disk or another other media, which can be used for storing information and/or data and can be accessed in the computing device 2200.

The computing device 2200 may further include additional detachable/non-detachable, volatile/non-volatile memory medium. Although not shown in FIG. 22, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 2240 communicates with a further computing device via the communication medium. In addition, the functions of the components in the computing device 2200 can be implemented by a single computing cluster or multiple computing machines that can communicate via communication connections. Therefore, the computing device 2200 can operate in a networked environment using a logical connection with one or more other servers, networked personal computers (PCs) or further general network nodes.

The input device 2250 may be one or more of a variety of input devices, such as a mouse, keyboard, tracking ball, voice-input device, and the like. The output device 2260 may be one or more of a variety of output devices, such as a display, loudspeaker, printer, and the like. By means of the communication unit 2240, the computing device 2200 can further communicate with one or more external devices (not shown) such as the storage devices and display device, with one or more devices enabling the user to interact with the computing device 2200, or any devices (such as a network card, a modem and the like) enabling the computing device 2200 to communicate with one or more other computing devices, if required. Such communication can be performed via input/output (I/O) interfaces (not shown).

In some embodiments, instead of being integrated in a single device, some or all components of the computing device 2200 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 2200 may be used to implement video encoding/decoding in embodiments of the present disclosure. The memory 2220 may include one or more video coding modules 2225 having one or more program instructions. These modules are accessible and executable by the processing unit 2210 to perform the functionalities of the various embodiments described herein.

In the example embodiments of performing video encoding, the input device 2250 may receive video data as an input 2270 to be encoded. The video data may be processed, for example, by the video coding module 2225, to generate an encoded bitstream. The encoded bitstream may be provided via the output device 2260 as an output 2280.

In the example embodiments of performing video decoding, the input device 2250 may receive an encoded bitstream as the input 2270. The encoded bitstream may be processed, for example, by the video coding module 2225, to generate decoded video data. The decoded video data may be provided via the output device 2260 as the output 2280.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for video processing, comprising:
performing a conversion between a current video unit of a video and a bitstream of the video, wherein a neural network (NN) filter is applied to the current video unit for the conversion,
wherein at least one output of at least one intermediate layer in the NN filter is normalized with layer normalization, and/or
wherein the NN filter comprises a vanilla convolutional layer and at least one of: a depth-wise convolutional layer, or a group convolutional layer, and/or
wherein the NN filter is applied to the current video unit for the conversion based on an attention.

2. The method of claim 1, wherein the at least one output of the at least one intermediate layer in the NN filter is normalized with layer normalization, and wherein the layer normalization is conducted for each channel in the at least one output of the at least one intermediate layer.

3. The method of claim 1, wherein the NN filter comprises the vanilla convolutional layer and the depth-wise convolutional layer, and an element in an output channel is determined by involving corresponding elements in an input channel corresponding to the output channel.

4. The method of claim 1, wherein the NN filter comprises the vanilla convolutional layer and the group convolutional layer, and an element in an output channel is determined by involving corresponding elements in a plurality of input channels corresponding to the output channel.

5. The method of claim 4, wherein at least one input channel of the NN filter is excluded from the plurality of input channels.

6. The method of claim 1, wherein the NN filter is applied to the current video unit for the conversion based on the attention, wherein the attention comprises a channel attention determined from an output of an intermediate layer in the NN filter, and the channel attention is used to recalibrate the output.

7. The method of claim 6, wherein the channel attention is obtained by squeezing spatial information of the output of the intermediate layer into channels and scaling the channels with a vector.

8. The method of claim 7, wherein the channel attention is determined by A=W×pool(G), where A denotes the channel attention, W∈R^{N} denotes a weighting vector, pool( ) denotes a pooling function, and G∈R^{N×W×H} denotes the output of the intermediate channel, N, W, and H are the channel numbers, width, and height respectively.

9. The method of claim 8, wherein the attention is applied by: φ^{i,j,k}=G^{i,j,k}×Aⁱ, 1≤i≤N, 1≤j≤W, 1≤k≤H, where φ denotes recalibrated feature maps.

10. The method of claim 8, wherein the attention is applied by: φ^{i,j,k}=G^{i,j,k}×f(Aⁱ), 1≤i≤N, 1≤j≤W, 1≤k≤H, where φ denotes recalibrated feature maps, and f denotes a mapping function applied on each element of the attention, or
wherein the attention is applied by: φ^{i,j,k}=G^{i,j,k}×f(Aⁱ)+G^{i,j,k}, 1≤i≤N, 1≤j≤W, 1≤k≤H, where φ denotes recalibrated feature maps, and f denotes a mapping function applied on each element of the attention.

11. The method of claim 10, wherein the mapping function comprises one of: a sigmoid function, or a hyperbolic tangent function.

12. The method of claim 10, wherein a first attention for a first channel of feature maps is different from a second attention for a second channel of the feature maps, and/or
wherein a first mapping function for the first channel of the feature maps is different from a second mapping function for the second channel of the feature maps.

13. The method of claim 1, wherein the NN filter is applied to the current video unit for the conversion based on the attention, and wherein the attention is applied to at least one predetermined layer inside the NN filter.

14. The method of claim 1, wherein the NN filter is applied to the current video unit for the conversion based on the attention, and wherein a gate function is utilized by the NN filter in addition to a non-linear activation function.

15. The method of claim 14, wherein the gate function divides a feature map into a plurality of parts in a channel dimension and multiplies the plurality of parts of the feature map.

16. The method of claim 1, wherein the conversion includes encoding the current video unit into the bitstream.

17. The method of claim 1, wherein the conversion includes decoding the current video unit from the bitstream.

18. An apparatus for video processing comprising a processor and a non-transitory memory with instructions thereon, wherein the instructions upon execution by the processor, cause the processor to:
perform a conversion between a current video unit of a video and a bitstream of the video, wherein a neural network (NN) filter is applied to the current video unit for the conversion,
wherein at least one output of at least one intermediate layer in the NN filter is normalized with layer normalization, and/or
wherein the NN filter comprises a vanilla convolutional layer and at least one of: a depth-wise convolutional layer, or a group convolutional layer, and/or
wherein the NN filter is applied to the current video unit for the conversion based on an attention.

19. A non-transitory computer-readable storage medium storing instructions that cause a processor to perform operations comprising:
performing a conversion between a current video unit of a video and a bitstream of the video, wherein a neural network (NN) filter is applied to the current video unit for the conversion,
wherein at least one output of at least one intermediate layer in the NN filter is normalized with layer normalization, and/or
wherein the NN filter comprises a vanilla convolutional layer and at least one of: a depth-wise convolutional layer, or a group convolutional layer, and/or
wherein the NN filter is applied to the current video unit for the conversion based on an attention.

20. A non-transitory computer-readable recording medium storing a bitstream of a video which is generated by a method performed by an apparatus for video processing, wherein the method comprises:
generating the bitstream of the video from a current video unit of the video, wherein a neural network (NN) filter is applied to the current video unit of the video,
wherein at least one output of at least one intermediate layer in the NN filter is normalized with layer normalization, and/or
wherein the NN filter comprises a vanilla convolutional layer and at least one of: a depth-wise convolutional layer, or a group convolutional layer, and/or
wherein the NN filter is applied to the current video unit for the conversion based on an attention.
